(19) United States
(12) Patent Application Publication
(10) Pub. No.: US 2014/0074842 A1
(43) Pub. Date: Mar. 13, 2014

(54) Computer Method and System for Detecting the Subject Matter of Online Communications

(71) Applicants: Lior Tal, Tel-Mond (IL); Eran Borenstein, Los Gatos, CA (US)

(72) Inventors: Lior Tal, Tel-Mond (IL); Eran Borenstein, Los Gatos, CA (US)

(21) Appl. No.: 14/024,774

(22) Filed: Sep. 12, 2013

Related U.S. Application Data
(60) Provisional application No. 61/700,100, filed on Sep. 12, 2012.

(51) Int. Cl. G06F 17/30

(52) U.S. Cl. CPC G06F 17/30598
USPC 707/737

(57) ABSTRACT

A computer-implemented system and method for monitoring the electronic communications of a subject to determine if dangerous behavior is occurring, especially in social networking platforms. The PG Guard™ web service permits a parent to monitor all of a child's activities on a social site such as Facebook®. To maintain the privacy of the child, the service only provides information to the parents about suspicious activities comprising, for example: conversations regarding violence, sex, alcohol, etc.; when a stranger interacts with their child (or vice versa); when their child discloses personal information; when a friend seems to be of a problematic nature; when a child uploads or is tagged in new images; and when a child adds or rejects a new friend. The method comprises generating a profile of the subject based on their keywords and the probability of their intended meaning, as well as their posted “Likes” and “Recommendations”.

### CROSS-REFERENCE TO RELATED APPLICATION

This application claims the benefit of U.S. Provisional Application No. 61/700,100 filed Sep. 12, 2012, which is incorporated herein by reference in its entirety.

### BACKGROUND OF THE INVENTION

1. Field of the Invention

The present invention relates to a system and method for monitoring electronic communications. In particular, it relates to a means for a third party to determine in an automated manner the content of communications conducted between entities engaged in online communications.

2. Description of the Related Art

Emails, texts, instant messages, chats rooms and social network sites are the dominant form today of written communication between two or more parties. There are a variety of scenarios for a third party not directly privy to a written communication to nonetheless require knowledge of its content, with or without the other parties' permission—such as criminal or intelligence surveillance, monitoring of employee conduct by an employer, parents checking on their children's and their children's friends attitudes, activities, etc.

While methods of intercepting the messages are known in the art, automated methods of determining the contents of the communication are less precise, especially for short messages and when code words or slang are involved. Existing methods to detect subject of text are based on either: 1) identifying designated keywords; and/or, 2) extensive analysis of each word in a sentence.

In the first method, an algorithm searches for a collection of words designated as ones of interest, and if found, then the subject of the text is determined by these words. But many important events that include words with multiple meaning, such as balls, drink, etc., as well as slang words, will intentionally not be included in the algorithm to avoid false alerts.

In the second method, intensive computational algorithms analyze the text to find sentence building blocks (e.g. subject, adjectives, verb, etc.), and then try to figure out what is the subject of the text based upon the potential meaning of each word. This method requires massive computational resources to analyze the text and provide results.

Two parties communicating can also intentionally act to outsmart the algorithm. For example, WO 2011/137279 by Baer et al entitled “Email, Text and Message Monitoring System and Method” discloses a method of allowing parents to block messages from designated individuals, such as incorporating lists of local sexual predators. But, once a parent has approved of an individual to communicate with their child, the system will only flag a future communication if a particular “bad” word is used. A child could easily circumvent the system by substituting words to hide the true meaning of the communication.

Likewise, United States Patent Application 20110178793 by Giffin et al entitled “Dialogue Analyzer Configured to Identify Predatory Behavior” discloses a method of assigning words as “primitive”—e.g. root words related to topics of concern requiring monitoring, wherein the words are associated by a similar sound, meaning, use, spelling, appearance and covers proper English, common misspellings, slang and leetspeak. The processor then raises an alert when primitive words are found within a designated proximity to each other in an electronic communications, such as two primitive words located with six or less non-primitive words between them (See FIG. 11, 12). The child could outsmart the system by limiting the number of “red flag” words and their proximity to each other.

Therefore, there is a need for a computerized method and system to monitor nonencrypted electronic communications so as to efficiently and accurately identify dangerous content of particular concern to a third party. In particular, there is a need for a computerized method and system to monitor social networks accounts, such as Facebook® and Twitter®, to detect dangerous conversations comprising common language with slang, abbreviations, misspellings, etc.

### SUMMARY OF THE INVENTION

The present invention comprises a computer program product, a computer system and method, to monitor the electronic communications of a subject or entity (e.g. user of a web site), such as their incoming and outgoing emails, instant messages, posts, etc., to detect dangerous activities and attitudes of the subject that might be a concern to a third party (or one of the participants). The software conducts a computer analysis on the content of the communications and activities of the subject from which it creates a personality profile of them. The profile and activity is then used to determine to a certain degree of probability whether the subject-entity is engaged in or considering specific types of behavior and activities that are of a concern to the third party, whom will subsequently be notified. The third party is also only informed regarding the behavior that is of a legitimate concern to the third party, while other content of the subject's communication is maintained in privacy.

In one embodiment, the present invention comprises the product, system and method of PG Guard™, wherein a parent joins the “PG Guard” group on a social networking website, such as Facebook®. The present invention then permits the parent (i.e. user) to monitor the activity of their child (i.e. subject); their communications to and from their friends (i.e. entitites); the “Likes” and “Recommends” posted by the child; etc. The Subject Matter Detection and Reporting Software of the present invention creates a profile of the child based upon their electronic communications on Facebook®—friends and groups. To maintain the privacy of the child, the system of the present invention only provides information to the parents about suspicious activities comprising, for example: conversations regarding violence, sex, alcohol, etc.; when a stranger interacts with their child (or vice versa); when their child discloses personal information; when a friend seems to be of a problematic nature; when a child uploads or is tagged in new images; and when a child adds or rejects a new friend.

Server system software will profile each party (e.g. Subject) being monitored and create a unique profile for the subject, and the individuals with whom they electronically communicate. The software will then analyze their online communications based upon their particular profile as compared to the general population so as to determine their true intent when using ambiguous words, abbreviations, code, and/or slang words with multiple meanings. The system will immediately notify the user (e.g. client) when conversations are detected that produced a positive result. For example, an alert is sent to a parent when the software determines that a child is potentially engaged in drug use, or an employer is notified when it appears that an employee is engaged in intellectual property theft.

The software creates three different types of tables to create a profile unique to each subject: a General Category Table; a Dictionary Table; and a Personal Categories Table.

The “General Categories Table” is created and stored by the server software for the general population that is being monitored by the software. The table comprises categories on the x-axis that are monitored (e.g. bullying, alcohol use, etc.), versus keywords on the y-axis that are searched for in the electronic communications. The keywords comprise words, phrases, symbols, abbreviations, leetspeak and/or slang that may: 1) have a single meaning related to any of the categories; 2) have multiple meanings where some meanings are related to more than one category; or 3) have one or more meanings that are not related to any category.

The General Categories Table (GCT) comprises a count (N) for each keyword “K” and category “C”. This count represents the number of times the keyword “K” appears in documents classified as “C”.

Furthermore, the “General Categories Table” also comprises a column within each category listing an estimate of the likelihood, or probability, of each keyword having a meaning of each of the categories as determined by the software. For example, the keyword “ice” in the general population is calculated by the system server based on the count (N) to have a 20% probability of referring to drugs, and an 80% probability of referring to frozen water (i.e. category is “NONE” for not referring to any of the other categories within the “General Categories Table”). The GCT uses the category-keyword counts (N) to compute the likelihoods.

A “Personal Categories Table” is created from the “General Categories Table” with the same categories and keywords, but with probabilities and counts that are specific to the subject. The Personal Categories Table (PCT) also comprises “counts (N)” indicating the number of times a keyword was detected by the system server/software from an analysis of all of the subject's body of electronic communications over a set period of time. The software also allows for the analysis to be done on only the subject's correspondence of a particular type (e.g. personal messages, chat messages, etc.). The probabilities listed in the PCT are computed by the PCT and GCT when the number of counts (N) for an individual are not enough to give a high statistical confidence value. For example, when a subject is first monitored by the system, the true meaning of his words are unclear (e.g. does “ice” mean “drugs”?). As time passes and more samples of the subject's electronic communications are monitored by the system, then the more reliable the system becomes in correctly assigning the true meaning of the word and message as a whole.

The third type of table created by the system server and software comprises a “Dictionary Table”. This table is derived of all the words and expressions in a certain language, such as English, French, etc. and is used by the software to recognize and categorize keywords. The Dictionary Table is structured the same as the PCT and GCT above with all the keywords having a likelihood for innocent intent (e.g. None category is 100%).

Next the text is parsed into tokens and mapped to the vocabulary of keywords (features). The mapping is done using best match to keywords that are either in the GCT/PCT or in the Dictionary according to a Levenshtein distance. This step corrects spelling mistakes and other factors contributing to word variations.

The system server/software will analyze the keywords within the context of the text that it is found in to determine which category to assign it to. Therefore, the system analyzes not only the keyword, but the other words that it is used with, in order to determine the true meaning of the word and hence the communication, even if the word is code or slang or has multiple meanings. The system will also take into account the context of the text, such as in public chat rooms versus personal emails, wherein the latter is weighted more heavily in determining the true intended meaning of the keyword. And the system will factor in other online disclosures that the Subject makes in order to determine the true meaning of keywords: such as memberships in organizations, their declared online “Likes” and “Recommendations”, etc. In otherwords, the system classifies the electronic communication as a whole rather than just a collection of words.

If a keyword is classified under more than one category, then the system server/software calculates the probability of the word to be classified under one of the categories based on data from the General Categories Table and the Subject's Personal Categories Table. After the result is produced (i.e. the intended meaning of the text is related, or not, to one of the pre-defined categories), then both the General Categories Table for all Subjects, and the Personal Categories Table of that specific subject are updated in accordance with procedure described in the Detailed Description Section.

Subject Profiling: the software searches electronic communications both sent and received by the Subject, and the probability of the parties' intended meaning. In doing so it builds a separate profile of each subject and the entities with whom they communicate. The profile comprises the particular probability of the subject's intended meaning with the keyword (e.g. Personal Table) versus the keywords' meaning in the general population (e.g. General Category Table). A subject and their entities will become “labeled” with a particular profile or characteristic once enough communications are analyzed and determined to become statistically significance, and the user/administrator will be notified of this.

The Subject Matter Detection and Monitoring Software “learns” from the stream of correspondences of a subject and corrects the categories, keywords, and their probabilities accordingly. For example, the probabilities assigned by the software administrator when the tables are created are an educated estimate which is corrected with each communication that is positive for keywords falling within a category on the tables. Then, when the algorithm starts to receive messages along with entities (each message comes with an entity—the person whom the subject is communicating with), the algorithm: 1) checks if the entity already exists and if not, creates a new personal table for the new entity (e.g. a friend of the original subject, now becomes another subject within the system); 2) analyzes the message for keywords and their intended meanings; and 3) updates the probabilities, count, keywords, and categories within the GCT and PCT according to the outcome of the server/processors analysis.

The present invention also provides a feedback mechanism. The administrator, user or other entity can notify the system server when they believe that a keyword and/or a particular communication have been miscategorized. The system will then re-calculate the keyword count and adjust the tables and profiling accordingly.

Therefore, the system is constantly updating the personal and general tables using automatic, contextual feedback and manual feedback. The system classifies the entire text to a specific category providing context and the context is used to update the counts of individual words within this context. Manuall feedback can help the system remove mistakes and correct counts of words and expressions that contributed to the mistakes.

The present invention can also be used to classify entire websites and webdomains in a similar manner. If a website contains content that is mostly classified as violent content, then the website can be classified as such. This information, that can be extracted automatically from the system, can be useful to other parental control devices and software that enable users to block access to a specific list of websites (e.g. all violent websites).

### BRIEF DESCRIPTION OF THE DRAWINGS

The above and other features, aspects, and advantages of the present invention will become better understood with regard to the following description, appended claims, and accompanying drawings where:

FIG. 1 is a schematic diagram of the system architecture of the present invention.

FIG. 2 is a flowchart of the four primary stages in monitoring a subject's electronic communications.

FIGS. 3A-C are flowcharts of the steps in the Subject Matter Detection and Monitoring Software in creating a profile for a subject, and subsequently using the profile to ascertain the true meaning of a subject's electronic communications.

Reference will now be made in detail to the present preferred embodiments of the present invention, examples of which are illustrated in the accompanying drawings. Wherever possible, the same reference numbers are used in the drawings and the description to refer to the same or the like parts.

### DETAILED DESCRIPTION

### Glossary of Terms

As used herein, the term “User” refers to the entity who contracts with the system server to monitor the electronic communications of a “Subject”, and/or to receive notifications from the system server.

As used herein, the term “Subject” is the entity whose electronic communications are being monitored. The subject may be an individual, a group of individuals, an organization, etc. Both the User and the Subject communicate with the system server via “Client Electronic Computing Devices”.

As used herein, the term “Administrator” refers to the system personnel who control the Personal Categories Table and General Categories Table structure, such as the selecting keywords for a particular type of table (monitoring children's online communications).

As used herein, the term “Electronic Computing Device” refers to any electronic device comprising a central processing unit (i.e. processor) with the ability to transmit and receive electronic communications from the system server and between parties being monitored, and may comprise devices with cellular phone capacity and/or with Voice over Internet Protocol (VoIP) phone capability via a web connectivity, such as: laptops, desktops, Android® tablets, iPads, and smartphones, cell phones, and personal digital assistant devices. The electronic computing device also has the ability to run the software of the present invention to process, compute and store the information it is retrieving and sending.

As used herein, the term “Electronic Communication” and “Content” refers to any kind of digital information transmitted within electronic communications that is being monitored, such as messages (chat—e.g. IM, social network sites; SMS via 3G and 4G networks; email, etc.) viewed on a Subject's computing device (e.g. smartphone). The term also refers to actions the subject takes to express an opinion, such as “Like” or “Recommend”.

As used herein, the term “Software” refers to computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present invention comprise any software components, programs, applications, computer programs, application programs, system programs, machine programs, and operating system software.

As used herein, the term “Algorithm” refers to a portion of a computer program or software that carries out a specific function and may be used alone or combined with other algorithms of the same program.

As used herein, the term “A System” may be used to claim all aspects of the present invention wherein it refers to the entire configuration of hardware and software in all embodiments. In one embodiment, the “system” comprises a client-server architecture comprising a client computing device with web connectivity, such as laptops, tablets, and smartphones, to communicate with a system server via a network, wherein the software of the present invention is installed on the system server and electronically communicates with the user to, for example, provide alerts. The preferred system further comprises the system server monitoring or intercepting via the network electronic communications between the subject (e.g. child) and their entity contacts, wherein the subject is communicating using a client computing device with web connectivity, such as laptops, tablets, and smartphones. In an alternative embodiment, the system may further comprise the ability to intercept and monitor communications conducted via cellular networks, such as text messages.

As used herein, the term “Category” is the topic or subject matter that the system server is monitoring for in the subject's electronic communication. The categories are automatically selected by the system server and/or by the user.

As used herein, the term “Keyword” refers to a words, phrases, symbols, and/or slang, and any combination thereof that may: 1) have a single meaning related to any of the categories; 2) have multiple meanings where some meanings are related to more than one category; and/or, 3) have one or more meanings that are not related to any category.

As used herein, the term “Levenshtein distance” between two data strings refers to the minimum number of edits needed to transform one string into the other, with the allowable edit operations being insertion, deletion, or substitution of a single character.

As used herein, the term “Token” refers to the Levenshtein distance that is the minimum number of changes in spelling required to change one word into another.

### General System Architecture

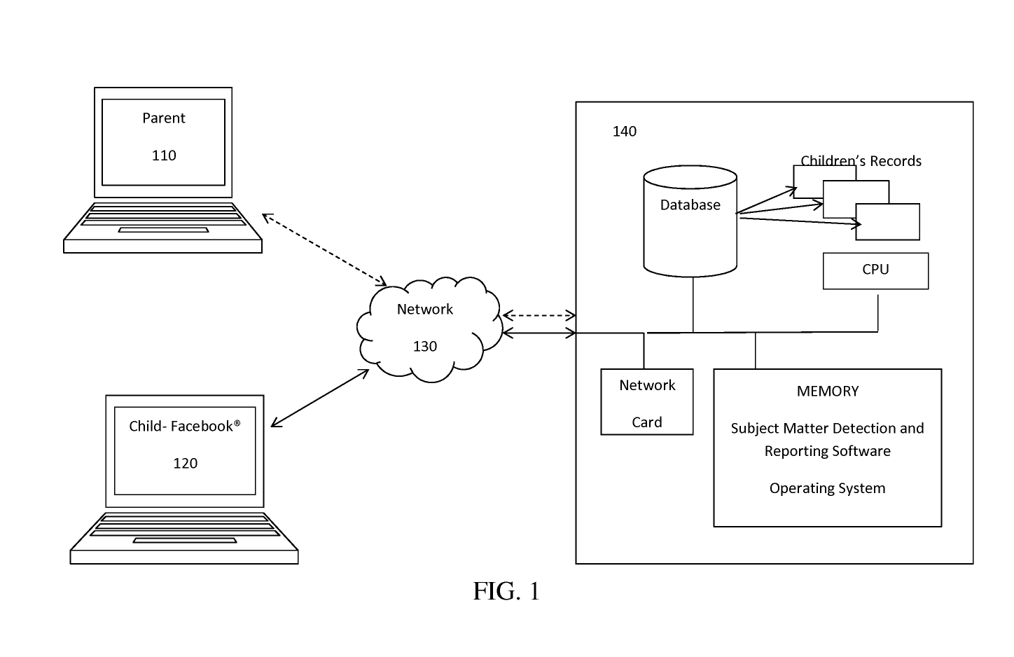

As illustrated in FIG. 1, the general system architecture of the present invention comprises the following: 1) a Client Computer System 110 of the user creating an account on the computer system to monitor a subject (e.g. Parent's laptop); 2) a Subject Computer System 120 of the entity being monitored (e.g. child); 3) a Network 130; and 4) a System Server 140 to communicate with the client and subject computer systems.

The “Network” comprises any public network such as the Internet or World Wide Web, or any public or private network as may be developed in the future, which provides a similar service as the present Internet. A Client System 110 is a User's electronic communications device with web browser capabilities (e.g., laptop, smartphone, etc. . . . ) configured to communicate with the System Server 140 via the Network 130, in order to receive and respond to system reports regarding the subject's electronic communications activities. Likewise, the Subject System 120 is a Subject's electronic communications device with web browser capabilities (e.g., laptop, smartphone, etc. . . . ) configured to be monitored by the System Server 140 via the Network 130. The User's and Subject's System may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the Network. In one embodiment of the invention, the Subject System 120 is also a User System 110, wherein the subject knows that they are being monitored, and the subject receives and responds to the reports generated by the system server 140 regarding the subject's electronic communications. In other embodiments of the invention, wherein the subject does not know that they are being monitored, such as employees being notified that their company email account may be monitored, the subject will not have access to the report.

The Service Provider System 140 of the present invention comprises: a network card or other device for connecting to the Network 130; a Memory unit comprising random access memory (RAM) for program execution, flash memory, and hard disc drive and storing the subject matter detection and reporting software of the present invention; a central processing unit (CPU or processor(s)) executing the subject matter detection and reporting software; and a system database storing records of the User's Account and Subject's Activity. Records may comprise, for example: the User's registration on the system; logs of Subject's communications time-stamped; analysis of the Subject's communications via the detection and reporting software of the present invention; reports sent to the User regarding the Subject's activity (e.g. alerts); communications wherein the User and/or Subject respond to the reports with, for example, corrections and rebuttals.

### General Process/Method

The present invention may be used in a variety of settings, such as a web service or within a social network and chat room environment that requires registration of the user and subject on the system, or embedded within the system software. One exemplified embodiment is for use in a social network website (e.g. Facebook®) and/or an online chatroom, which may require that the user registers with the system server and creates an account. The manner and webpage for registration is dependent upon on the type of electronic communication being monitored. For example, the user may register: 1) on the server's website; or 2) on the web service of the type of account being monitored (Facebook, YouTube, MySpace, Twitter, Gmail, Hotmail, AOL Instant Messaging, Skype, etc.).

If the latter (2), the user logs into their account of the website, then enters the webpage of the system server (e.g. PG Guard™ on Facebook®). They select whether to allow or not allow (i.e. skip) the system server/software (e.g. PG Guard™) to: 1) post on subject's behalf (application may post on subject's behalf, including status updates, photos, and more); and 2) access subject's data anytime (allows app to access user's data when they are not using the app).

The software will then allow the user to connect with the subject's account. For example, in Facebook®, if the user is already a “friend” of the subject, then the user selects the subject from the list of friends, copies and sends the system message that the subject will receive in their private message account on Facebook®. If the user is not a “friend” of the subject, then the user enters the subject's name and Facebook® email address. A message is then sent with an invitation link to the subject's regular email. If the subject accepts the user as a friend, they will be notified that they are also accepting permission for the system server to monitor their communications. Additionally, the system may embed a notification on the subject's webpage to notify others that the subject's communications are being monitored (e.g. a PG Guard™ shield and a warning statement).

It is noted that in additional embodiments of the present invention, permission for a user to monitor a subject may be inherently granted. For example, employees of a company are notified upon hiring that their electronic communications on the employer's system (e.g. company internal email) may be monitored. In such a case, when the employee creates their company email account, or at any time later, the employer may deploy the Subject Matter Detection and Monitoring Software on their system server to monitor the employee's ingoing and outgoing emails and instant messages.

The system server then builds a profile on the subject based upon their electronic communications, and creates a General Categories Table (GCT) and a Personal Categories Table.

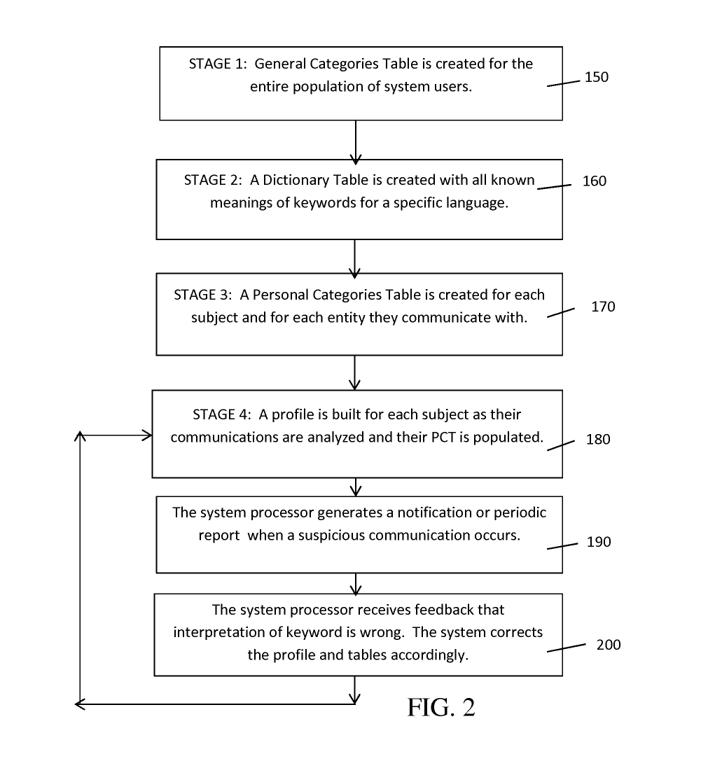

The system server/CPU/software then engages in a four stage process comprising the following steps (see also FIG. 2). In Stage 1 the General Categories Table (GCT) is created by the administrator according to the purpose of the monitoring. For example, the PG Guard™ is used for parents to monitor their children's online behavior, and the categories and keywords are selected accordingly, with categories such as “Drugs” and keywords would such as “cocaine” and “marijuana”. The “Keywords” refers to words, phrases, symbols, and/or slang, and any combination thereof, that may: 1) have a single meaning related to any of the categories; 2) have multiple meanings where some meanings are related to more than one category; and/or, 3) have one or more meanings that are not related to any category. The administrator also assigns an initial probability of the keywords intended meaning when creating the GCT. The probability of each keyword is subsequently updated by the CPU as the subject's electronic communications are analyzed.

In Stage 2, the system server/software/CPU creates a Dictionary Table comprising all known meanings of keywords for a specific language. In Stage 3, it then creates a Personal Categories Table (PCT) for each subject being monitored, wherein each entity that communicates with the original subject will also have a PCT. In Stage 4 a profile is built for each subject as their electronic communications are analyzed and their PCT is populated.

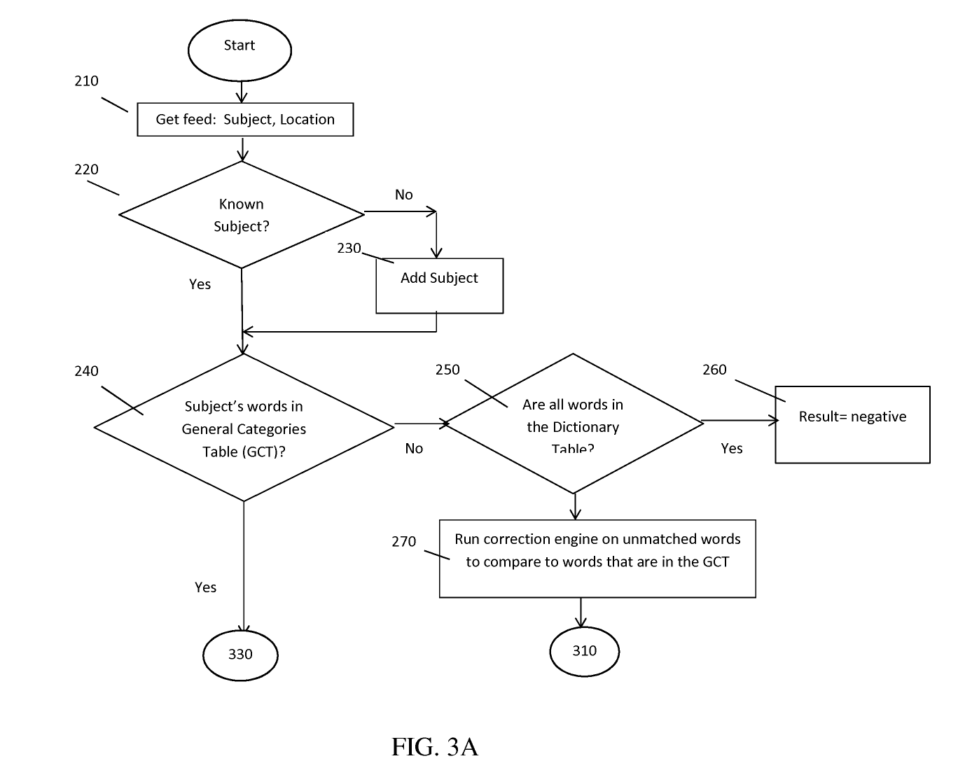

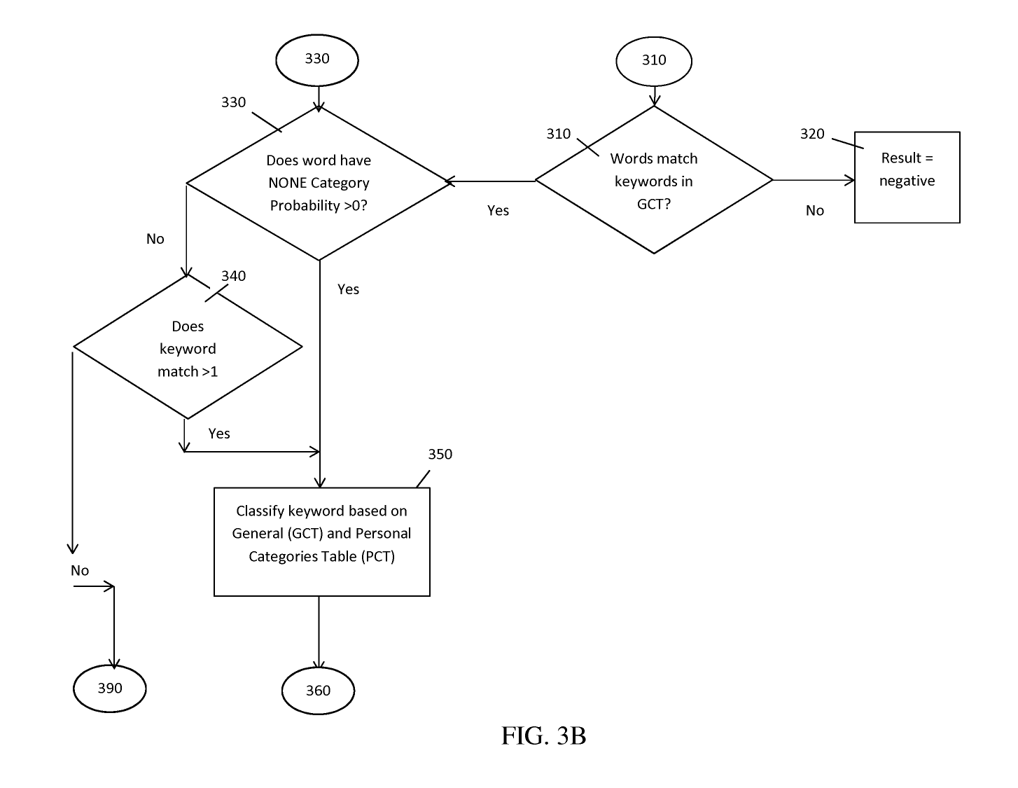

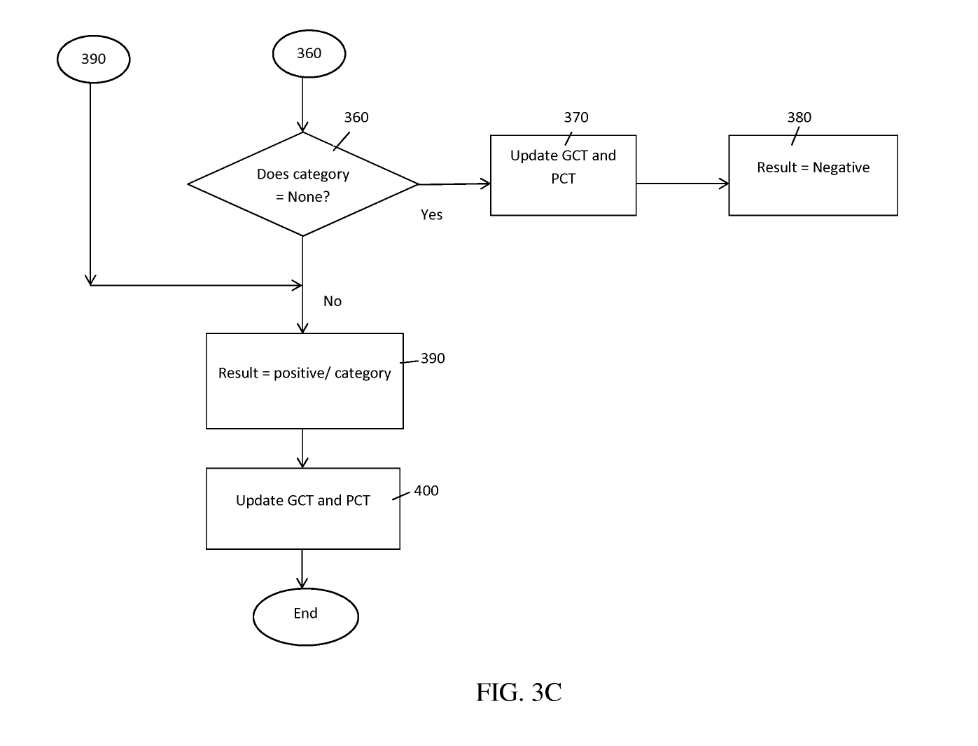

The system server subsequently tags an electronic communication sent or received by the original subject and sends an immediate alert to the administrator and/or user (and to the subject if desired by the user) when a dangerous situation requires immediate intervention. Or, the system server includes the incident in the regularly scheduled report (e.g. a user can elect to receive a system update every few days for suspicious incidents or areas of concern, and then an immediate alert to their email account). The tagging and classification of the subject's communications is based upon the analysis by the Subject Matter Detection and Monitoring Software of the keywords within the content of the communication and based upon the subject's profile, GCT and PCT (see also FIGS. 3A-C). The PCT and GCT counts of all keywords in the classified document are then updated by the latest analysis providing an automatic system feedback.

The software may also receive feedback to correct a misinterpretation of keywords. For example, the user and/or the administrator may subsequently review the results and reports and find that there is an error in how the system server interpreted the true meaning of a communication. For example, the subject may have sent a message using a keyword with an ambiguous meaning, and the system interpreted it as a keyword within a category of concern on the GCT and PCT. The user and/or subject may then notify the system server of the mistake, and the subject's profile, GCT, and PCT will be recalculated with the new interpretation of the keyword.

### Subject Matter Detection and Reporting Software

### General Categories Table (GCT)

As illustrated in flowchart of computer processor steps in FIG. 2, the present invention follows four general stages when monitoring a subject's electronic communications. In Stage 1, the system processor creates a General Categories Table (step 150) for each type of monitoring and comprises categories and keywords set by the software or system administrator. For example in a parental control application, the table may include CATEGORIES such as NONE, INSULTS, SEX, VIOLENCE, SMOKING AND DRUGS, ALCOHOL AND MENTAL STATE. Then, keywords (e.g. words, slang, symbols, leetspeak, etc.) that may have either a single meaning related to any of these CATEGORIES, or multiple meanings where some meanings are related to more than one CATEGORY, or one or more meaning is not related to any CATEGORY is listed. Then, an initial estimate of the likelihood (Probability—P) of each keyword to have a meaning for each of the CATEGORIES is added. The count (Number—N) will be filled with the number of times (i.e. counts) each keyword is detected for a certain category. For example as shown in Table 1, if a subject wrote the keyword “ice” and the server/software/CPU decided that the meaning of ice in this case was drugs, then “1” will be added to the keyword ice under column N.

TABLE 1
GENERAL CATEGORIES TABLE

| | | | | | | | | | | | SMOKING | | MENTAL | |
|---|---|---|---|---|---|---|---|---|---|---|---|---|---|---|
| | NONE | | INSULT | | VIOLENCE | | SEX | | ALCOHOL | | & DRUGS | | STATE | |
| | P | N | P | N | P | N | P | N | P | N | P | N | P | N |
| Ice | 80% | | 0 | | 0 | | 0 | | 0 | | 20% | 1 | 0 | |
| Marijuana | 0 | | 0 | | 0 | | 0 | | 0 | | 100% | | 0 | |
| Balls | 50% | | 0 | | 0 | | 50% | | 0 | | 0 | | 0 | |
| Pebbles | 33% | | 0 | | 0 | | 33% | | 0 | | 33% | | 0 | |
| F**k you | 0 | | 100% | | 0 | | 0 | | 0 | | 0 | | 0 | |

In every language and scenario in which this invention may be used, there will be many keywords that fall under one of the following types: 1) have a single meaning (i.e. belong to a single category, such as “Marijuana” only belongs to the category “SMOKING & DRUGS”); 2) one or more meanings that are not related to any of the categories (i.e. Category=NONE) and one or more meanings that are related to a category (e.g. “Pebbles” belongs in three categories with equal probability of their intended meaning: NONE, SEX, and SMOKING & DRUGS): and 3) one or more meanings that are related to a known category.

It is also noted that in a one embodiment illustrated in steps 150-170 of FIG. 2, the system processor utilizes tokens to match content in the electronic communication to keywords in the GCT and PCT. A token is a string of characters, categorized according to the rules as a symbol. Therefore the system is able to analyze misspelling, abbreviations, etc. and appropriately categorize them (e.g. “iice” would be identified as “ice”). Every token is matched with all keywords in the dictionary that have a “Levenshtein distance”, which is a metric that calculates a score indicating the number of substitutions and deletions needed in order to transform one input string (e.g. “iice”) into another (e.g. “ice”). Finding all keywords in a PCT and/or GCT that have a small, set Levenshtein distance to a given token is accomplished using a Trie search tree. One of skill in the art would readily know of methods to use Trie search trees and Levenshtein distance based tokens with the present invention.

### Dictionary Table

In Stage 2, after or concurrently with creating the General Categories Table (GCT) for all subjects, the server/software/CPU will create a Dictionary Table (FIG. 2, step 160) comprising all of the known keywords (e.g. words, slang, symbols, leetspeak, acronyms, etc.) for a specific language (e.g. English, Hebrew, etc.) that the subject uses. If the subject is bilingual, or more, a Dictionary Table will be created for each language, or alternatively all language versions of a keyword are combined into one table. Methods of making a Dictionary Table are well known to the skilled artisan, such as using an online dictionary to populate a table.

### Personal Categories Table (PCT)

In Stage 3, the system server/software/CPU will create a Personal Categories Table (PCT) (FIG. 2, step 170) for the subject. A PCT will also be created for each entity that the subject receives and/or transmits electronic communications with (e.g. friends, groups, promotional information, etc.) as per Table 2, although the software has no knowledge of the relationships between entities and hence is not aware if a certain entity is a friend or not of the subject. Both the General Categories Table and the Personal Categories Tables of each subject-entity may comprise the same categories and keywords.

After the content of a certain subject is analyzed by the software, and it is determined that one or more keywords relates to one or more categories on the GCT and PCT, the PCT table of the subject is updated accordingly. The count (N) is increased by one for every category that the software determines a particular keyword belongs in. For example, if the words “ice” was detected in the subject's latest Facebook® post or comment with a friend, and the software analysis determined that its intended meaning was for the drug (and not the frozen water), then the count (N) under the box for the keyword “ice” and the category “SMOKING & DRUGS” would be increased by “1” (See Table 2).

TABLE 2
PERSONAL CATEGORIES TABLE

| | | | | | | | | | | | SMOKING | | MENTAL | |
|---|---|---|---|---|---|---|---|---|---|---|---|---|---|---|
| | NONE | | INSULT | | VIOLENCE | | SEX | | ALCOHOL | | & DRUGS | | STATE | |
| | P | N | P | N | P | N | P | N | P | N | P | N | P | N |
| Ice | 0 | | 0 | | 0 | | 0 | | 0 | | 100% | 1 | 0 | |
| Marijuana | 0 | | 0 | | 0 | | 0 | | 0 | | 100% | | 0 | |
| Balls | 50% | | 0 | | 0 | | 50% | | 0 | | 0 | | 0 | |
| Pebbles | 33% | | 0 | | 0 | | 33% | | 0 | | 33% | | 0 | |
| F**k you | 0 | | 100% | | 0 | | 0 | | 0 | | 0 | | 0 | |

### Classification Engine Algorithm

In Stage 4, after the subject is registered with the system server (e.g. username and ID assigned), the Subject Matter Detection and Reporting Software (SMDRS) of the present invention starts modifying/updating the subject's profile, PCT, and GCT, as outlined in the flowchart of events FIGS. 3A-C (See also FIG. 2, step 180). As the SMDRS software starts to receive and analyze electronic communications on the subject's monitored account, the software checks whether the entity that sent the message already has a record on the system database, and if not, then it creates one. Therefore, every entity that the original subject electronically communicates with will have a PCT and profile generated for them by the server/software/CPU.

When the content of an entity's (e.g. the original subject's or their contact's) electronic communication is analyzed and a keyword that exists in the GCT is detected AND the keyword is classified under a single category, then the system software updates the count (N) of the keyword in the subject's GCT and the PCT stored on the system database. The incident (e.g. keyword and context and assigned category) is subsequently reported as a positive result to the administrator, and to the user affiliated with the original subject, in the periodic report, or immediately if a dangerous situation is determined to exist by the system processor.

If the keyword is classified under more than one category, then the algorithm calculates the probability of the word to be classified under one of the categories based on data from the subject's GCT and PCT. If the algorithm classifies the word under a category different than NONE, then the positive result along with category are sent in a report to the user. The algorithm also updates the count (N) on the subject's GCT and PCT.

The system server sends an alert or periodic report to the user or administrator when a suspicious communication occurs, and/or with the subject's profile (FIG. 2, step 190). The user and/or administrator review the report and may notify the system if it is incorrect in its classification of a particular meaning of a keyword or communication. The system will incorporate the feedback into the subject's record and correct their profile and the GCT and PCT tables accordingly (200).

The system server-processor follows the steps as per the flowchart in FIGS. 3A-C. In FIG. 3A, step 210, “Get Feed”, the central processing unit (CPU) on the system server identifies the subject of the electronic communication and their digital location (i.e. PRIVATE MESSAGE VS PUBLIC POSTING). For example, the subject may be the child, their friends or a group to wish they belong and the digital location on Facebook may be a “private document” section.

In step 220, the processor next determines if the subject is already registered in the system server and has a file stored in the system database.

In step 230, if the subject is not already registered (either voluntarily, or implicitly), then the CPU will create a file—Personal Category Table—for them and begin to create/modify/update their profile along with the General Categories Table. The CPU will analyze and record all incoming and outgoing messages, their location and their timestamps and identify keywords. As per the exemplification above, the processor would create a file for the child or their friend or the group who sent the electronic communication. Hence, monitoring the communications of one subject may generate multiple files of other subjects and their profiles and tables.

In step 240 the CPU will determine if the identified keywords in a particular communication(s) are included in the subject's General Categories Table.

In step 250, if they are NOT in the General Categories Table, then the CPU will determine are all their keywords in the Dictionary Table. Alternatively, the GCT and PCT tables exist without a dictionary table if all possible keywords in the communication are in the tables wherein some of them have only the “None” interpretation.

In step 260, if none of the words are in General Category Table and all the keywords are in the Dictionary Table, then the result is negative for adding the keywords from the communication(s) to the GCT.

In step 270, for those keywords that are not in the Dictionary Table, the CPU of the system server will run a correction engine on the unmatched words/symbols to compare to those listed as keywords in the General Categories Table. The system server/processor then proceeds to step 310 on FIG. 3B.

FIG. 3B is a flowchart of events that is a continuation of FIG. 3A. In step 310, after the system server processor runs a correction engine on the unmatched words/symbols to compare to those listed as keywords in the General Categories Table, it determines whether or not the words match the keywords in the General Categories Table.

In step 320, if they do not, then the result is negative for adding the keywords from the communication(s) to the GCT.

In step 330, if the keywords are included in the GCT, then the server/processor determines whether or not the keywords have a NONE Category probability greater than 0. This occurs when the keyword has at least one meaning that is NOT associated with any category in the GCT, and at least one meaning that is associated with one or more categories in the GCT.

In step 340, if the keywords does NOT have a NONE category probability greater than 0, then the server/processor determines whether the keywords match more than one category in the GCT other than “NONE”.

In step 350, if the keywords do match more than one category on the GCT, or if they have a NONE category probability greater than zero, then the CPU calculates the probability of the electronic communication being classified under one of the categories based on the data from the GCT and PCT.

FIG. 3C is a flowchart of events that is a continuation of FIG. 3B. In step 360, the system processor determines if the keywords is in the NONE category.

In step 370, if so, then the count (N) of the keywords within the subject's GCT and PCT is increased accordingly.

In step 380, and a positive result is reported to the user.

In step 390, a positive result is also reported to the user if the server/processor classifies the keywords under a category different than NONE (i.e. the category is not equal to NONE because the keyword has at least a greater than 1% probability of falling within one category on the GCT other than NONE). A positive result is also reported to the user if the keywords match more than one category in step 340.

In step 400, the count (N) on the subject's GCT and PCT are updated with an increase of (1) count for each keyword that generates a positive report.

### User Profiling

As illustrated in FIGS. 3B and 3C, steps 350-400, as more of a subject's electronic communication content is analyzed, the subject's Personal Categories Table (PCT) is constantly updated and reflects their tendencies towards each category compared with the general population. In the parental control application, for example, a subject that constantly writes messages determined by the software to relate to violence will be categorized as a subject with a tendency to violence. Hence, when the same content with a keyword that is classified under category VIOLENCE and NONE is written by this subject and by another subject with no such tendency, it is possible that the outcome for one will be POSITIVE/VIOLENCE and for the other NEGATIVE (no category).

The software of the present invention is also enabled to receive feedback, such as from a user or administrator about the results, and adjust the subject's General Categories Table (GCT) and Personal Categories Table accordingly. For example, in parental control application, when a parent receives the result, a parent can provide feedback that a result provided is either false or that it is related to a different category then the algorithm classified. In this case, the algorithm—processor uwill “undo”/cancel the changes in the subject's GCT and PCT that were the result of the initial calculation and updates the tables according to the feedback provided. Hence, feedback provides assistance in “teaching”/fine-tuning the algorithm.

### Additional Profiling Factor—User's Actions

When using a social network application such as Facebook® (but others as well), there are certain actions a subject can take that reflects the subject's positive or negative attitude towards certain topics. For example, within the Facebook® social network, the subject can select “like” or “share” for certain content, which reflects the subject's support/positive view of the content. The software of the present invention factors in these subject's actions to more accurately profile the subject and their tendencies.

### Additional Profiling Factor—Location of Text

The software will also take into account the location of content as a better indicator for subject's tendencies. For example, if the message received/monitored by the system server is collected from private interactions (i.e. Facebook® personal messages or chat) as opposed to public interactions, the algorithm adds a factor to private interactions as they tend to disclose the subject's tendencies more accurately.

Although the invention has been described with reference to specific embodiments thereof, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

What is claimed is:

1. A computer system for detecting and monitoring the subject matter of an entity's electronic communications, comprising:
a) a system server, comprising;
i) a database that stores records for each entity whose electronic communications are analyzed by the system;
ii) a non-transitory computer-readable storage device comprising instructions for processor(s), wherein said processors are configured to execute said instructions to perform operations comprising;
creating a general categories table comprising categories, keywords, and the probability of said keyword having a specific meaning for the type of behavior being monitored, wherein said table represents the general population;
creating a dictionary table comprising all known meanings of all keywords for a specific language; —creating a personal categories table for each of said entities within said database comprising identical categories and keywords as said general categories table; and,
generating a profile for each entity as their electronic communications are analyzed by said processor(s) and their personal categories table is populated;
b) two or more client computers comprising a graphical user interface for communicating with said system server; and,
c) a network for transmitting electronic communications between said client systems and said server system.

2. The computer system of claim 1, wherein said keywords comprise words, phrases, symbols, abbreviations, leetspeak and/or slang: 1) that may have a single meaning related to any of the categories; 2) have multiple meanings where some meanings are related to more than one category; or 3) have one or more meanings that are not related to any category.

3. The computer system of claim 2, wherein said general categories table and said personal categories table further comprise a probability for each keyword having a meaning for a particular category.

4. The computer system of claim 3, wherein said tables further comprise a count for the number of times said keyword is determined by said processor(s) to have a meaning falling within a particular category.

5. The computer system of claim 1, further comprising said processor(s) generating and transmitting to said client computer a notification or periodic report when a suspicious communication is identified.

6. The computer system of claim 5, further comprising said client computer transmitting feedback to said processor(s) correcting the interpretation of a keyword, and adjusting said tables and profiles accordingly.

7. The computer system of claim 1, wherein said client systems comprise a parent and one or more of their child's computer systems with Internet connectivity, and wherein said electronic communications are within a social network website.

8. The computer system of claim 7, wherein said social network website comprises Facebook®.

9. A computer implemented method for detecting and monitoring the subject matter of an entity's electronic communications, comprising processor(s) on a system server:
a) creating a general categories table comprising categories, keywords, and the probability of said keyword having a specific meaning for the type of behavior being monitored, wherein said table represents the general population;
b) creating a dictionary table comprising all known meanings of all he keywords for a specific language;
c) creating a personal categories table for each of said entities within a system database comprising identical categories and keywords as said general categories table; and,
d) generating a profile for each entity as their electronic communications are analyzed by said processor(s) and their personal categories table is populated.

10. The computer implemented method of claim 9, wherein said keywords comprise words, phrases, symbols, abbreviations, leetspeak and/or slang: 1) that may have a single meaning related to any of the categories; 2) have multiple meanings where some meanings are related to more than one category; or 3) have one or more meanings that are not related to any category.

11. The computer implemented method of claim 10, wherein said general categories table and said personal categories table further comprise a probability for each keyword having a meaning for a particular category.

12. The computer implemented method of claim 11, wherein said tables further comprise a count for the number of times said keyword is determined by said processor(s) to have a meaning falling within a particular category.

13. The computer implemented method of claim 9, further comprising said processor(s) generating and transmitting to a client computer via a network a notification or periodic report when a suspicious communication is identified.

14. The computer implemented method of claim 13, further comprising said client computer transmitting feedback to said processor(s) correcting the interpretation of a keyword, and adjusting said tables and profiles accordingly.

15. The computer implemented method of claim 9, wherein said client systems comprise a parent and one or more of their child's computer systems with Internet connectivity, and wherein said electronic communications are within a social network website.

16. The computer implemented method of claim 15, wherein said social network website comprises Facebook®.

17. A computer program product embodied in a non-transitory computer readable medium that, when executing on one or more computers, performs the steps of:
a) creating a general categories table comprising categories, keywords, and the probability of said keyword having a specific meaning for the type of behavior being monitored, wherein said table represents the general population;
b) creating a dictionary table comprising all known meanings of all the keywords for a specific language;
c) creating a personal categories table for each of said entities within a system database comprising identical categories and keywords as said general categories table; and,
d) generating a profile for each entity as their electronic communications are analyzed by said processor(s) and their personal categories table is populated.

18. The computer program product of claim 17, wherein said keywords comprise words, phrases, symbols, abbreviations, leetspeak and/or slang: 1) that may have a single meaning related to any of the categories; 2) have multiple meanings where some meanings are related to more than one category; or 3) have one or more meanings that are not related to any category.

19. The computer program product of claim 18, wherein said general categories table and said personal categories table further comprise a probability for each keyword having a meaning for a particular category.

20. The computer program product of claim 19, wherein said tables further comprise a count for the number of times said keyword is determined by said processor(s) to have a meaning falling within a particular category.

21. The computer program product of claim 17, further comprising said processor(s) generating and transmitting to a client computer via a network a notification or periodic report when a suspicious communication is identified.

22. The computer program product of claim 21, further comprising said client computer transmitting feedback to said processor(s) correcting the interpretation of a keyword, and adjusting said tables and profiles accordingly.

23. The computer program product of claim 22, wherein said client systems comprise a parent and one or more of their child's computer systems with Internet connectivity, and wherein said electronic communications are within a social network website.

24. The computer program product of claim 23, wherein said social network website comprises Facebook®.
